(19) United States
(12) Patent Application Publication
(10) Pub. No.: US 2014/0349809 A1
(43) Pub. Date: Nov. 27, 2014

(54) APPARATUS FOR DRIVING PLUG-IN HYBRID VEHICLE AND METHOD OF CONTROLLING THE SAME

(71) Applicant: Hyundai Motor Company, Seoul (KR)

(72) Inventor: Insup KIM, Anyang-si (KR)

(73) Assignee: HYUNDAI MOTOR COMPANY, Seoul (KR)

(21) Appl. No.: 14/058,120

(22) Filed: Oct. 18, 2013

(30) Foreign Application Priority Data
May 22, 2013 (KR) 10-2013-0057784

(51) Int. Cl. B60W 20/00; B60W 10/196; B60K 6/365; B60W 10/02

(52) U.S. Cl. CPC B60W 20/10; B60W 10/02; B60W 10/196; B60K 6/365; Y10S 903/93
USPC 477/4; 477/3; 180/65.265; 903/930

(57) ABSTRACT

The apparatus may include an engine configured to supply a drive torque to the vehicle. A first motor generator directly connected to the engine and generates electric power and supplies the drive torque to a transmission. A clutch is interposed between the first motor generator and the transmission and selectively transmits rotational power between the first motor generator and the transmission. A second motor generator is electrically connected to the first motor generator and generates electric power and supplies the drive torque to the transmission at all times. A battery supplies the electric power to the first and second motor generators and is charged by the first and second motor generators.

### CROSS-REFERENCE TO RELATED APPLICATION

This application claims the benefit of priority to Korean Patent Application No. 10-2013-0057784, filed on May 22, 2013, which is incorporated herein by reference in its entirety.

### TECHNICAL FIELD

The present disclosure relates to an apparatus for driving a plug-in hybrid vehicle in which a planetary gear, a clutch, and a brake are combined, and more particularly, to an apparatus for driving a plug-in hybrid vehicle in which efficient driving is possible in a typical traveling region using one electric vehicle mode and two hybrid electric vehicle modes and a method of controlling the same.

### BACKGROUND

In general, an apparatus for driving a plug-in hybrid vehicle can realize an electric vehicle (EV) mode, a series (engine charge and motor drive) mode, and a power split mode in combination with a clutch and a brake. When a battery is sufficiently charged, the vehicle can travel only in the EV mode within a charge depleting range.

However, when the battery reaches a lower limit, the vehicle travels in the series and power split modes while maintaining the battery state-of-charge (SOC) within a charge sustaining range.

As shown in FIG. 1, a conventional apparatus for driving a plug-in hybrid vehicle uses two clutches and is driven by two motors. In detail, when an EV1 mode of an EV mode is set, a brake BK is operated. When an EV2 mode of the EV mode is set, a second clutch CL2 is operated. Thereby, the vehicle travels with electric power only. Meanwhile, when a series mode of a hybrid electric vehicle (HEV) mode is set, the brake BK and a first clutch CL1 are operated. When a power split mode of the HEV mode is set, the first clutch CL1 and the second clutch CL2 are operated. Thereby, the vehicle travels by splitting powers of an engine and first and second motor generators MG1 and MG2.

Here, the EV2 mode is used in a high-speed low-load region and is rarely used in a typical traveling region. As such, the EV2 mode occupies only 7% of a fuel efficiency authentication traveling mode of North American Urban Dynamometer Driving Schedule (UDDS). That is, even when the EV2 mode is replaced with the EV1 mode, the equivalent level of fuel efficiency is obtained. Thus, the number of parts is unnecessarily increased to constitute the two clutches.

### DOCUMENTS OF RELATED ART

(Patent Document 1) US Patent Application Publication No. 2008/0243322

### SUMMARY

An embodiment of the present disclosure provides an apparatus for driving a plug-in hybrid vehicle, capable of simplifying a structure and maintaining fuel efficiency.

Exemplary embodiments of the present disclosure can be understood by the following description. Also, it is apparent to those skilled in the art to which the present disclosure pertains that objects and advantages of the present disclosure can be realized by the means as claimed and combinations thereof.

In accordance with an embodiment of the present disclosure, an apparatus for driving a plug-in hybrid vehicle includes an engine configured to supply a drive torque to the vehicle. A first motor generator is directly connected to the engine and generates electric power and supplies the drive torque to a transmission. A clutch is interposed between the first motor generator and the transmission and selectively transmits rotational power between the first motor generator and the transmission. A second motor generator is electrically connected to the first motor generator and generates electric power and supplies the drive torque to the transmission at all times, and a battery supplies the electric power to the first and second motor generators and is charged by the first and second motor generators.

Here, the transmission may be configured in a single pinion planetary gear set, the single planetary gear set having a sun gear, a ring gear, and a planetary carrier.

The ring gear may be selectively connected to a transmission case by a brake and be rotated or fixed.

The sun gear may be rotated along with the second motor generator.

In addition, the planetary carrier may be directly connected to an output shaft of the vehicle.

In accordance with another embodiment of the present disclosure, a method of controlling an apparatus for driving a plug-in hybrid vehicle is provided. The apparatus includes a planetary gear set, the planetary gear set having a sun gear, a ring gear, and a planetary carrier, a first motor generator supplied with rotational power of an engine of the vehicle, and a second motor generator electrically connected to the first motor generator. A battery supplies electric power to the first and second motor generators, and a clutch is interposed between the first motor generator and the ring gear. When a driving condition of the vehicle is set to an electric vehicle (EV) mode, a brake is fastened to rotate or fix the ring gear and to release the clutch.

Here, when the driving condition of the vehicle is less than a set vehicle speed and is set to a low-speed hybrid electric vehicle (HEV) mode, the clutch may maintain a released state, and the brake may be fastened, and thereby, the engine power may generate electric power from the first motor generator and drive the second motor generator.

Further, when the driving condition of the vehicle exceeds the set vehicle speed and is set to a high-speed hybrid electric vehicle (HEV) mode, the clutch may be fastened, and the brake may be released, and thereby, outputs of the engine and the second motor generator may be simultaneously supplied to an output shaft of the vehicle through the planetary carrier.

### BRIEF DESCRIPTION OF THE DRAWINGS

FIG. 1 schematically shows a configuration of a conventional apparatus for driving a plug-in hybrid vehicle.

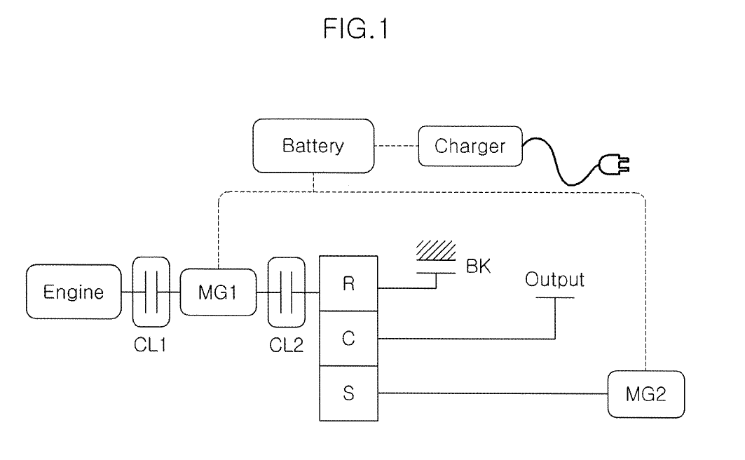

FIG. 2 shows an operation table of frictional elements applied to FIG. 1.

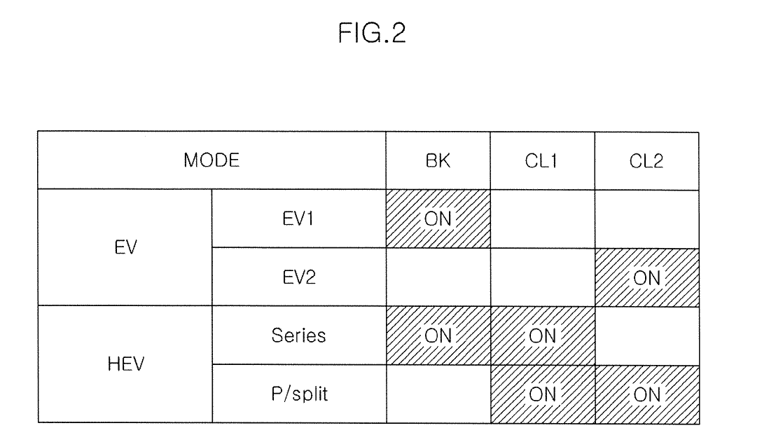

FIG. 3 schematically shows a configuration of an apparatus for driving a plug-in hybrid vehicle in accordance with an embodiment of the present disclosure.

FIG. 4 shows an operation table of frictional elements applied to FIG. 3.

FIG. 5 shows a power transmission flow in an electric vehicle mode of a method of controlling a plug-in hybrid vehicle in accordance with an embodiment of the present disclosure.

FIG. 6 shows a power transmission flow in a low-speed hybrid electric vehicle mode of the method of controlling the plug-in hybrid vehicle in accordance with an embodiment of the present disclosure.

FIG. 7 shows a power transmission flow in a high-speed hybrid electric vehicle mode of the method of controlling the plug-in hybrid vehicle in accordance with an embodiment of the present disclosure.

### DETAILED DESCRIPTION

Exemplary embodiments of the present disclosure will be described below in more detail with reference to the accompanying drawings. The present disclosure may, however, be embodied in different forms and should not be construed as limited to the embodiments set forth herein.

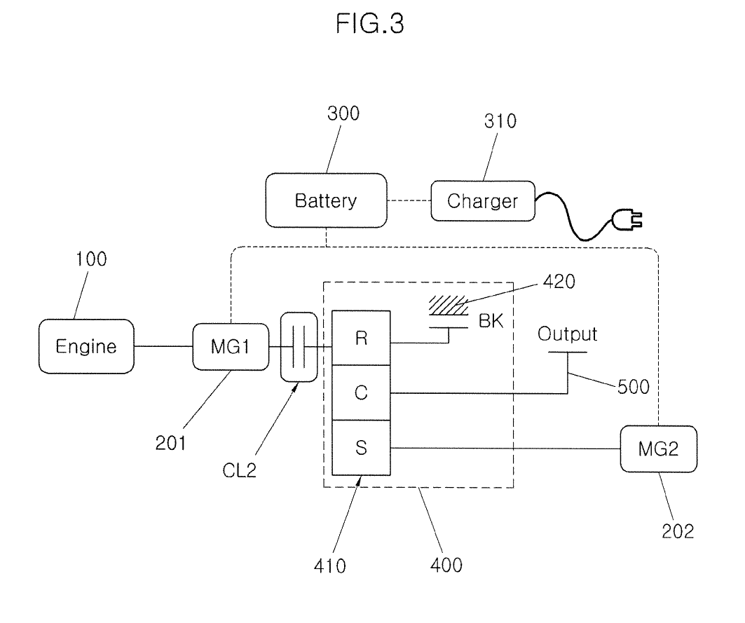

FIG. 3 schematically shows a configuration of an apparatus for driving a plug-in hybrid vehicle in accordance with an embodiment of the present disclosure. As shown in FIG. 3, an apparatus for driving a plug-in hybrid vehicle in accordance with an embodiment of the present disclosure includes an engine 100, a first motor generator 201, a second motor generator 202, a battery 300, a transmission 400, an output shaft 500, and frictional elements CL2 and BK. A drive torque of the vehicle is generated by the engine 100. A crank shaft (not shown) of the engine 100 is directly connected to the first motor generator 201.

Further, the first motor generator 201 is connected to the second motor generator 202 to supply electric power by the battery 300. Here, a charger 310 is connected to the battery 300 so as to be able to charge electric power.

The transmission 400 may include a single pinion planetary gear set 410 having a sun gear S, a planetary carrier C, and a ring gear R. The sun gear S is directly connected to the second motor generator 202, and the planetary carrier C is directly connected to the output shaft 500. The ring gear R is selectively connected to a transmission case 420 by the brake BK, thereby being rotated or fixed.

The clutch CL2 is interposed between the first motor generator 201 and the ring gear R of the transmission 400 so as to selectively connect the first motor generator 201 with the ring gear R.

The apparatus for driving a plug-in hybrid vehicle in accordance with an embodiment of the present disclosure as described above and a method of controlling the same will be described below in detail.

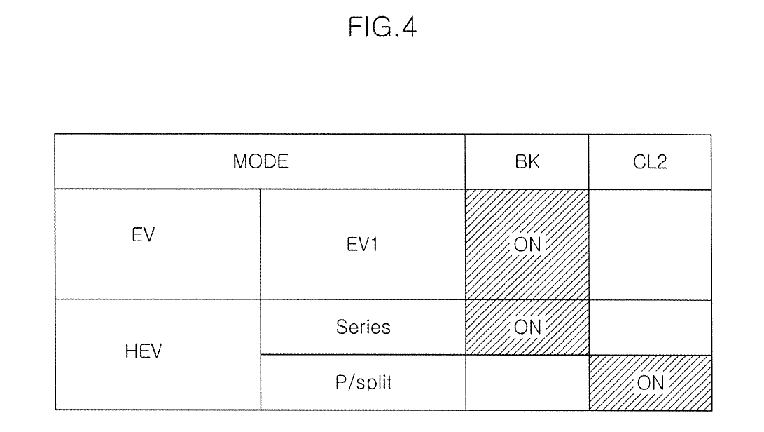

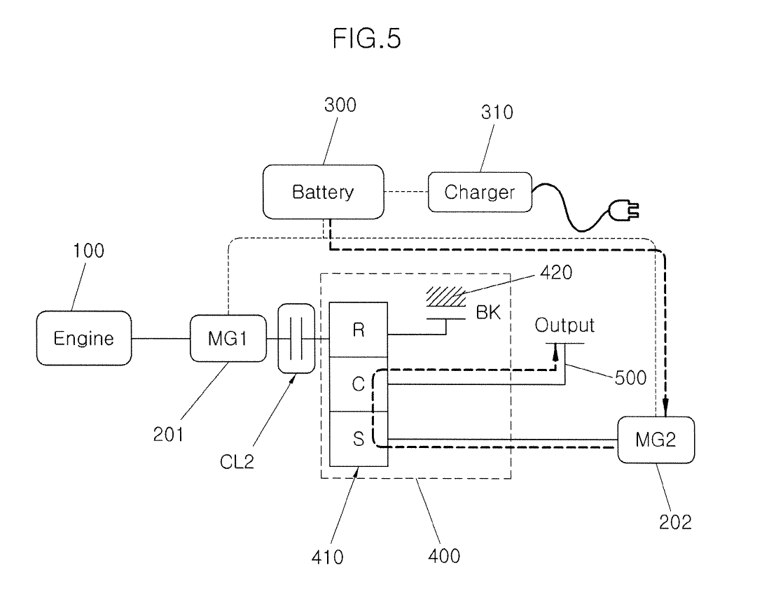

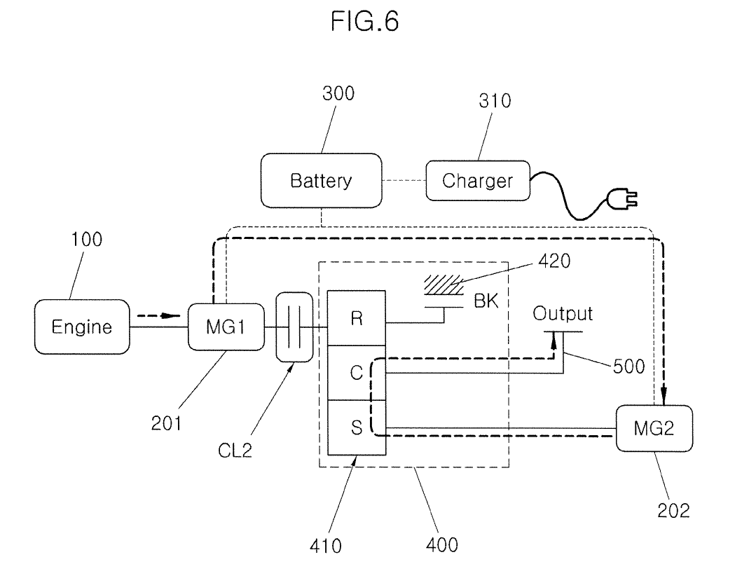

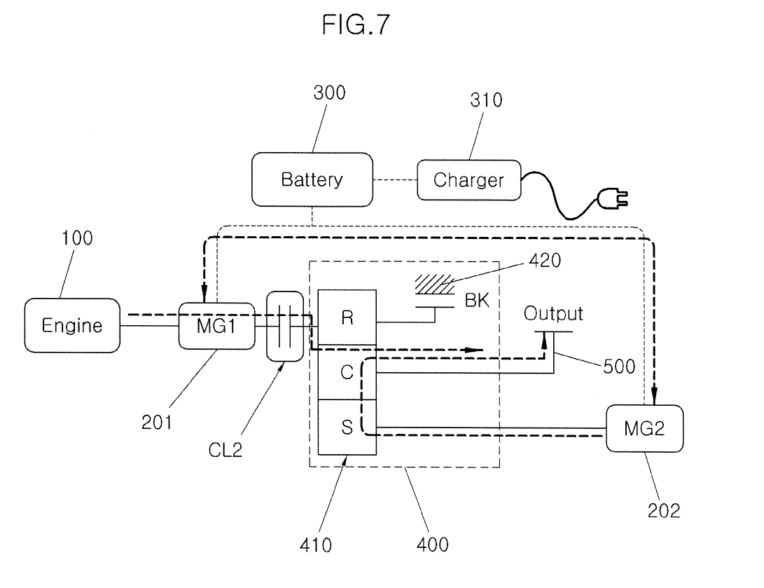

FIG. 4 shows an operation table of frictional elements applied to FIG. 3. FIG. 5 shows a power transmission flow in an electric vehicle mode of a method of controlling a plug-in hybrid vehicle in accordance with an embodiment of the present disclosure. FIG. 6 shows a power transmission flow in a low-speed hybrid electric vehicle mode of the method of controlling the plug-in hybrid vehicle in accordance with an embodiment of the present disclosure. FIG. 7 shows a power transmission flow in a high-speed hybrid electric vehicle mode of the method of controlling the plug-in hybrid vehicle in accordance with an embodiment of the present disclosure.

Referring to FIG. 4, when a driving condition of the vehicle is set to an electric vehicle (EV) mode, the brake BK is operated, and thereby, the ring gear R is fixed, and the clutch CL2 is released. That is, as shown in FIG. 5, the ring gear R of the transmission 400 is fixed by the brake BK. As such, a speed ratio reduced through the planetary carrier C is output. Here, electric power of the battery 300 is supplied only to the second motor generator. Thus, the second motor generator 202 is driven so that the vehicle travels with only the electric power with which the battery 300 is charged.

Further, as shown in FIG. 4, when the driving condition of the vehicle is less than a set vehicle speed and is set to a low-speed hybrid electric vehicle (HEV) mode, the clutch CL2 maintains a released state, and the brake BK is operated. Thereby, as shown in FIG. 6, the first motor generator 201 directly connected to the engine 100 generates the electric power, and simultaneously the second motor generator 202 is independently driven. Thus, the electric power generation of the first motor generator 201 and the driving of the second motor generator 202 are performed at the same time. Here, the set vehicle speed may be set to, for example, 100 km/h or so.

When the driving condition of the vehicle exceeds the set vehicle speed and is set to a high-speed HEV mode, the brake BK is released, and simultaneously the clutch CL2 is engaged. Thereby, as shown in FIG. 7, the first motor generator 201 directly connected to the engine 100 is directly connected to the ring gear R of the transmission 400 by the clutch CL2. As such, an output of the engine 100 is transmitted to an output shaft 500 through the planetary carrier C. A driving force of the second motor generator 202 directly connected to the sun gear S is transmitted to the output shaft 500 through the planetary carrier C.

As described above, according to the apparatus for driving a plug-in hybrid vehicle of the present disclosure, one clutch is removed, compared to the prior art. This reduces volume, cost, and drag amount generated in a clutch release condition.

In accordance with an exemplary embodiment of the present disclosure, one clutch is removed, compared to the prior art, so that a structure can be simplified.

Further, the clutch between the engine and the first motor generator is removed, and thus, volume of a power train and a total length are reduced. This facilitates package.

While the present disclosure has been described with respect to the specific embodiments, it will be apparent to those skilled in the art that various changes and modifications may be made without departing from the spirit and scope of the disclosure as defined in the following claims

What is claimed is:

1. An apparatus for driving a plug-in hybrid vehicle, comprising:
an engine configured to supply a drive torque to the vehicle;
a first motor generator directly connected to the engine and configured to generate electric power and supply the drive torque to a transmission;
a clutch disposed between the first motor generator and the transmission and configured to selectively transmit rotational power between the first motor generator and the transmission;
a second motor generator electrically connected to the first motor generator and configured to generate electric power and to supply the drive torque to the transmission continually; and
a battery configured to supply the electric power to the first and second motor generators and charged by the first and second motor generators.

2. The apparatus of claim 1, wherein the transmission is configured in a single pinion planetary gear set, the single pinion planetary gear set having a sun gear, a ring gear, and a planetary carrier.

3. The apparatus of claim 2, wherein the ring gear is selectively connected to a transmission case by a brake and is rotated or fixed.

4. The apparatus of claim 3, wherein the sun gear is rotated along with the second motor generator.

5. The apparatus of claim 4, wherein the planetary carrier is directly connected to an output shaft of the vehicle.

6. A method of controlling an apparatus for driving a plug-in hybrid vehicle, in which the apparatus includes a planetary gear set, the planetary gear set having a sun gear, a ring gear, and a planetary carrier, a first motor generator supplied with rotational power of an engine of the vehicle, a second motor generator electrically connected to the first motor generator, a battery configured to supply electric power to the first and second motor generators, and a clutch interposed between the first motor generator and the ring gear, wherein
when a driving condition of the vehicle is set to an electric vehicle (EV) mode, a brake is operated to rotate or fix the ring gear and to release the clutch.

7. The method of claim 6, wherein, when the driving condition of the vehicle is less than a set vehicle speed and is set to a low-speed hybrid electric vehicle (HEV) mode, the clutch maintains a released state, and the brake is fastened, and thereby the engine power generates electric power from the first motor generator and drives the second motor generator.

8. The method of claim 6, wherein, when the driving condition of the vehicle exceeds a set vehicle speed and is set to a high-speed hybrid electric vehicle (HEV) mode, the clutch is fastened, and the brake is released, and thereby outputs of the engine and the second motor generator are simultaneously supplied to an output shaft of the vehicle through the planetary carrier.
